(19) United States
(12) Patent Application Publication
(10) Pub. No.: US 2023/0207884 A1
(43) Pub. Date: Jun. 29, 2023

(54) Electrolyte Solution for Lithium Secondary Battery and Lithium Secondary Battery Comprising the Same

(71) Applicant: LG Energy Solution, Ltd., Seoul (KR)

(72) Inventors: Ji-Eun Song, Daejeon (KR); Jae-Gil Lee, Daejeon (KR); Eun-Ji Jang, Daejeon (KR); Chang-Hoon Lee, Daejeon (KR); Sueng-Hoon Han, Daejeon (KR)

(73) Assignee: LG Energy Solution, Ltd., Seoul (KR)

(21) Appl. No.: 18/085,896

(22) Filed: Dec. 21, 2022

(30) Foreign Application Priority Data
Dec. 23, 2021 (KR) 10-2021-0185761
Nov. 9, 2022 (KR) 10-2022-0148630

(51) Int. Cl. H01M 10/0569; H01M 10/052; H01M 4/58; H01M 4/40

(52) U.S. Cl. CPC H01M 10/0569; H01M 4/405; H01M 4/5815; H01M 10/052; H01M 2004/027; H01M 2300/0028

(57) ABSTRACT

An electrolyte solution for a lithium secondary battery and a lithium secondary battery including the same are disclosed herein. In some embodiments, an electrolyte solution includes a lithium salt, a nitrogen compound and an organic solvent, wherein the lithium salt comprises bis(trifluoromethanesulfonyl)imide (LiTFSI) and the organic solvent comprises an ether-based solvent. The electrolyte solution can have improved oxidation stability and storage stability at high temperature.

### CROSS-REFERENCE TO RELATED APPLICATIONS

The present disclosure claims priority from Korean Patent Application Nos. 10-2021-0185761, filed on Dec. 23, 2021, and 10-2022-0148630, filed on Nov. 9, 2022, the disclosures of which are incorporated by reference herein.

### TECHNICAL FIELD

The present disclosure relates to an electrolyte solution for a lithium secondary battery and a lithium secondary battery comprising the same.

### BACKGROUND ART

As lithium secondary batteries have expanded the range of applications to portable electronic instruments and even electric vehicles (EVs) and energy storage systems (ESSs), there is a growing demand for lithium secondary batteries with high capacity, high energy density and long service life.

Among different types of lithium secondary batteries, lithium-sulfur batteries are battery systems using sulfur-based materials containing sulfur-sulfur bonds for positive electrode active materials, and lithium metal, carbon-based materials in which intercalation/deintercalation of lithium ions occurs and silicon or tin that forms an alloy with lithium for negative electrode active materials.

In the lithium-sulfur batteries, sulfur, the main component of the positive electrode active material, has low atomic weight, and is plentiful, available, cost-effective, non-toxic and environmentally friendly.

In addition, the lithium-sulfur batteries have the theoretical specific capacity of 1,675 mAh/g by the conversion of lithium ions and sulfur at the positive electrode (Ss + 16 Li⁺ + 16e⁻ → 8Li₂S), and when lithium metal is used in the negative electrode, the theoretical energy density is 2,600 Wh/kg. Since the theoretical energy density of lithium-sulfur batteries is much higher than the theoretical energy density of other battery systems (Ni-MH batteries: 450 Wh/kg, Li-FeS batteries: 480 Wh/kg, Li-MnO₂ batteries: 1,000 Wh/kg, Na-S batteries: 800 Wh/kg) being currently studied and lithium-ion batteries (250 Wh/kg), lithium-sulfur batteries are gaining attention as high-capacity, eco-friendly and cost-efficient lithium secondary batteries among secondary batteries currently being developed.

The lithium-sulfur batteries undergo a reduction reaction in which sulfur accepts electrons at the positive electrode and an oxidation reaction in which lithium is ionized at the negative electrode during the discharge.

In the lithium-sulfur batteries, lithium polysulfide (Li₂Sₓ, x = 2 to 8) is produced at the positive electrode during the discharge, and some of the lithium polysulfide is dissolved in an electrolyte, causing side reaction in the battery, inducing faster degradation of the battery, and shuttle reaction occurs during the charge, resulting in significantly reduced charge/discharge efficiency. Moreover, lithium metal used for the negative electrode continuously reacts with the electrolyte, leading to accelerated decomposition of lithium salts and additives of the electrolyte.

To solve these problems, Korean Patent Publication No. 10-2016-0037084 discloses sulfur-containing carbon nanotube aggregates coated with graphene to prevent the dissolution of lithium polysulfide and increase the conductivity of the sulfur-carbon nanotube composite and the loading amount of sulfur.

However, the above-mentioned problem of the lithium-sulfur battery gets worse at high temperature, causing accelerated electrolyte decomposition, but the above-mentioned related art does not disclose any solution to the problems at high temperature.

Therefore, there is a need for the development of electrolytes with improved stability for the operation of lithium-sulfur batteries in high temperature environments.

### DISCLOSURE

### Technical Problem

After many studies to solve the above-described problems, the inventors found that when a lithium salt of an electrolyte solution for a lithium secondary battery comprises lithium bis(trifluoromethanesulfonyl)imide (LiTFSI), or lithium bis(trifluoromethanesulfonyl)imide (LiTFSI) and lithium bis(fluorosulfonyl)imide (LiFSI), it is possible to improve the oxidation stability and high temperature storage, and a lithium secondary battery comprising the electrolyte has improved life characteristics at high temperature, and based on this finding, they completed the present disclosure.

Therefore, the present disclosure is directed to providing an electrolyte solution for a lithium secondary battery with improved oxidation stability and high temperature storage.

The present disclosure is further directed to providing a lithium secondary battery comprising the electrolyte solution for a lithium secondary battery with improved life characteristics at high temperature.

### Technical Solution

To achieve the above-described objective, according to an aspect of the present disclosure, there is provided an electrolyte solution for a lithium secondary battery of the following embodiments.

The electrolyte solution for a lithium secondary battery according to a first embodiment comprises a lithium salt, a nitrogen compound and an organic solvent, wherein the lithium salt comprises lithium bis(trifluoromethanesulfonyl)imide (LiTFSI), and the organic solvent comprises an ether-based solvent.

According to a second embodiment, in the first embodiment, the LiTFSI may be included in an amount of 20 mol% or more based on a total number of moles of the lithium salt.

According to a third embodiment, in the first or second embodiment, a molar concentration of the lithium salt may be 0.1 to 4 M.

According to a fourth embodiment, in any one of the first to third embodiments, the lithium salt may further comprise lithium bis(fluorosulfonyl)imide (LiFSI), and a molar concentration of the LiTFSI may be equal to or higher than a molar concentration of the LiFSI

According to a fifth embodiment, in any one of the first to fourth embodiments, the ether-based solvent may be included in an amount of 80 vol% or more based on a total volume of the organic solvent.

According to a sixth embodiment, in any one of the first to fifth embodiments, the ether-based solvent may comprise at least one of a linear ether or a cyclic ether.

According to a seventh embodiment, in any one of the first to sixth embodiments, the linear ether may comprise at least one selected from the group consisting of dimethyl ether, diethyl ether, dipropyl ether, dibutyl ether, diisobutyl ether, ethyl methyl ether, ethyl propyl ether, ethyl tert-butyl ether, dimethoxymethane, trimethoxymethane, dimethoxyethane, diethoxyethane, dimethoxypropane, diethylene glycol dimethyl ether, diethylene glycol diethyl ether, triethylene glycol dimethyl ether, tetraethylene glycol dimethyl ether, ethylene glycol divinyl ether, diethylene glycol divinyl ether, triethylene glycol divinyl ether, dipropylene glycol dimethylene ether, butylene glycol ether, diethylene glycol ethyl methyl ether, diethylene glycol isopropyl methyl ether, diethylene glycol butyl methyl ether, diethylene glycol tert-butyl ethyl ether, and ethylene glycol ethyl methyl ether.

According to an eighth embodiment, in any one of the first to seventh embodiments, the cyclic ether may comprise at least one selected from the group consisting of 2-methylfurane, 1,3-dioxolane, 4,5-dimethyl-dioxolane, 4,5-diethyl-dioxolane, 4-methyl-1,3-dioxolane, 4-ethyl-1,3-dioxolane, tetrahydrofuran, 2-methyltetrahydrofuran, 2,5-dimethyltetrahydrofuran, 2,5-dimethoxytetrahydrofuran, 2-ethoxytetrahydrofuran, 2-methyl-1,3,-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxybenzene, 1,3-dimethoxybenzene, 1,4-dimethoxybenzene, and isosorbide dimethyl ether.

According to a ninth embodiment, in any one of the first to eighth embodiments, the organic solvent may have a dissolving power of 2 g/100 g or more for the nitrogen compound at room temperature based on 100 g of the organic solvent.

According to a tenth embodiment, in any one of the first to ninth embodiments, the room temperature may be in a temperature range of 20° C. to 35° C.

According to an eleventh embodiment, in any one of the first to tenth embodiments, the organic solvent may not comprise a carbonate-based solvent.

According to a twelfth embodiment, in any one of the first to eleventh embodiments, the carbonate-based solvent may include at least one of dimethyl carbonate, diethyl carbonate, dipropyl carbonate, ethylmethyl carbonate, methylpropyl carbonate, ethylpropyl carbonate, ethylene carbonate, propylene carbonate, 1,2-butylene carbonate, 2,3-butylene carbonate, 1,2-pentylene carbonate, 2,3-pentylene carbonate, vinylene carbonate, vinylethylene carbonate, or a halide thereof.

According to a thirteenth embodiment, in any one of the first to twelfth embodiments, the nitrogen compound may comprise a nitric acid compound or a nitrous acid-based compound.

According to a fourteenth embodiment, in any one of the first to thirteenth embodiments, the nitrogen compound may be included in an amount of 2 wt% to 10 wt% based on a total weight of the electrolyte solution for a lithium secondary battery.

According to a fifteenth embodiment, in any one of the first to fourteenth embodiments, the electrolyte solution retains, after storage at a temperature of 45° C. or more, 90 wt% or more LiTFSI relative to an initial weight of LiTFSI prior to storage.

According to a sixteenth embodiment, in any one of the first to fifteenth embodiments, the electrolyte solution retains, after storage at 45° C. or more for 4 weeks, 90 wt% to 98 wt% LiTFSI relative to an initial weight of LiTFSI prior to storage.

According to a seventeenth embodiment, in any one of the first to sixteenth embodiments, the storage temperature may be 45° C. to 65° C.

According to another aspect of the present disclosure, there is provided a lithium secondary battery of the following embodiments.

The lithium secondary battery according to an eighteenth embodiment comprises a positive electrode, a negative electrode, a separator between the positive electrode and the negative electrode, and an electrolyte solution, wherein the electrolyte solution is defined in any one of the first to seventeenth embodiments.

According to a nineteenth embodiment, in the eighteenth embodiment, the positive electrode may comprise a sulfur-containing compound as a positive electrode active material.

According to a twentieth embodiment, in the eighteenth or nineteenth embodiment, the sulfur-containing compound may comprise at least one of inorganic sulfur (Ss), lithium polysulfide (Li₂Sn, 1≤n≤8), or carbon sulfur polymer (C₂Sx)m, 2.5≤x≤50, 2≤m).

According to a twenty first embodiment, in any one of the eighteenth to twentieth embodiments, the negative electrode may comprise at least one of a lithium metal or a lithium alloy as a negative electrode active material.

According to a twenty second embodiment, in any one of the eighteenth to twenty first embodiments, the lithium secondary battery may be a coin-type battery or a pouch-type battery.

### Advantageous Effects

The electrolyte solution for a lithium secondary battery according to the present disclosure has high oxidation stability and improved storage stability at high temperature.

In addition, the lithium secondary battery comprising the electrolyte solution for a lithium secondary battery according to the present disclosure has improved life characteristics at high temperature.

### DESCRIPTION OF DRAWINGS

FIG. 1 is a photograph depicting the observed oxidation stability of an electrolyte solution for a lithium-sulfur battery according to some embodiments of the present disclosure.

FIG. 2 is a graph depicting the measured capacity retention of a lithium-sulfur battery after stored at high temperature in accordance with some embodiments of the present disclosure.

FIG. 3 is a graph depicting the measured life characteristics of a coin-cell type lithium-sulfur battery at high temperature in accordance with some embodiments of the present disclosure.

FIG. 4 is a graph depicting the measured life characteristics of a pouch-cell type lithium-sulfur battery at high temperature in accordance with some embodiments of the present disclosure.

FIG. 5 is a photograph depicting the evaluated solubility of a nitrogen compound by the type of organic solvent in accordance with some embodiments of the present disclosure.

### DETAILED DESCRIPTION

Hereinafter, the present disclosure will be described in more detail.

It should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprises” or “includes” when used in this specification, specify the presence of stated features, integers, steps, operations, elements, components or groups thereof, but do not preclude the presence or addition of one or more other features, integers, steps, operations, elements, components or groups thereof.

As used herein, the term “composite” refers to a material which is produced by combining or more materials to form a physically/chemically different phase and can perform more effective functions.

As used herein, the term “polysulfide” is the concept that encompasses “polysulfide ion (Sₓ²⁻, wherein x = 8, 6, 4, 2)” and “lithium polysulfide (Li₂Sₓ or Li₂Sₓ⁻, wherein x = 8, 6, 4, 2)”.

A lithium secondary battery, in particular, a lithium-sulfur battery, undergoes continuous reactions between a lithium negative electrode and an electrolyte during the charge and discharge, causing accelerated decomposition of a lithium salt, and as the temperature increases, the electrolyte decomposition occurs faster, resulting in low stability.

Lithium bis(fluorosulfonyl)imide (LiFSI) used as the lithium salt is not effectively invulnerable to decomposition of the lithium salt of the electrolyte solution, especially, the decomposition of the lithium salt occurring faster in high temperature environments of 45° C. or above, resulting in low stability.

An aspect of the present disclosure is aimed at solving the above-described problem.

### Electrolyte Solution for Lithium Secondary Battery

To solve the above-described problem, the present disclosure is directed to providing an electrolyte solution for a lithium secondary battery.

The electrolyte solution for a lithium secondary battery according to the present disclosure comprises a lithium salt, a nitrogen compound and an organic solvent, wherein the lithium salt comprises lithium bis(trifluoromethanesulfonyl)imide (LiTFSI), and the organic solvent comprises an ether-based solvent.

The LiTFSI has improved oxidation stability and high temperature stability and is less prone to decomposition under the continuous reactions between lithium metal as a negative electrode of a lithium secondary battery and an electrolyte. Therefore, in the present disclosure, when the LiTFSI is included as the lithium salt, it is possible to provide an electrolyte solution for a lithium secondary battery with improved oxidation stability and storage stability especially at high temperature, but the mechanism of the present disclosure is not limited thereto.

In the present disclosure, the storage stability at high temperature represents that the lithium salt does not completely decompose and parts of the lithium salt remain at the temperature of 45° C. or more when the electrolyte solution is applied to a lithium secondary battery. For example, the storage stability at high temperature may represent that the lithium salt applied to the electrolyte solution maintains 90 wt% or more of the initial weight of the lithium salt at the temperature of 45° C. or more when the electrolyte solution is applied to a lithium secondary battery.

In an embodiment of the present disclosure, for example, the LiTFSI may be included in an amount of 20 mol% or more based on the total number of moles of the lithium salt. For example, the LiTFSI may be included in an amount of 20 mol% to 100 mol%, 25 mol% to 95 mol%, 30 mol% to 90 mol%, 40 mol% to 80 mol%, 45 mol% to 75 mol%, 50 mol% to 75 mol%, or 60 mol%to 75 mol%, based on the total number of moles of the lithium salt. When the amount of the LiTFSI is in the above-described range, the LiTFSI will take the above-described effect, but the present disclosure is not limited thereto.

In another embodiment of the present disclosure, the lithium salt may further comprise another lithium salt in addition to the LiTFSI.

In an embodiment of the present disclosure, another lithium salt t, in addition to the LiTFSI, may be, for example, lithium bis(fluorosulfonyl)imide (LiFSI).

In an embodiment of the present disclosure, when the electrolyte solution for a lithium secondary battery comprises LiTFSI and LiFSI as the lithium salt, it is possible to obtain the above-described effect. When the electrolyte solution for a lithium secondary battery further comprises the LiFSI, to obtain the above-described effect, the molar concentration of the LiTFSI may be equal to or higher than the molar concentration of the LiFSI, and more specifically, preferably, the molar concentration of the LiTFSI may be higher than the molar concentration of the LiFSI, but the present disclosure is not limited thereto.

In an embodiment of the present disclosure, for example, the LiTFSI and the LiFSI may be included in a molar ratio of 1:5 to 5:1, 1:3 to 3:1, 1:2 to 2:1, 1:1.5 to 1.5:1, 1:1 to 1.5:1, 1:1 to 2:1, 1:1 to 3:1, 1.5:1 to 5:1 or 2:1 to 3:1. When the LiTFSI and the LiFSI are included in the above-described molar ratio, it is possible to improve the stability of the electrolyte solution, but the present disclosure is not limited thereto.

In an embodiment of the present disclosure, the concentration of the lithium salt may be appropriately determined considering the ion conductivity and solubility. For example, the concentration of the lithium salt may be 0.1 to 4 M, and preferably 0.5 to 2 M. When the concentration of the lithium salt is in the above-described range, it is possible to ensure ionic conductivity suitable for the operation of a battery or optimal viscosity of the electrolyte solution, thereby improving the lithium ion mobility and preventing the decomposition reaction of the lithium salt, but the present disclosure is not limited thereto.

In addition to the lithium salt, the nitrogen compound is dissolved in the electrolyte solution of a lithium secondary battery to provide ions, thereby improving the electrical conductivity of the lithium secondary battery, as well as improving the battery life characteristics when the electrolyte solution for a lithium secondary battery is used in the lithium-sulfur battery. Specifically, the efficacy of the nitrogen compound is not limited thereto, but for example, it is possible to prevent the reduction reaction of polysulfide that occurs during the charge/discharge of the lithium-sulfur battery, thereby preventing irreversible consumption of polysulfide, and as a consequence, improving the performance of the lithium-sulfur battery.

In an embodiment of the present disclosure, the nitrogen compound may include any type of nitrogen compound that forms a stable film on a lithium metal electrode or a negative electrode of a lithium secondary battery, to be specific, a lithium-sulfur battery and can improve the charge and discharge efficiency, and for example, the nitrogen compound may include at least one of a nitric acid compound or a nitrous acid based compound.

In an embodiment of the present disclosure, the nitrogen compound may be, for example, selected from the group consisting of at least one of an inorganic nitric acid or nitrous acid compound such as lithium nitrate (LiNO₃), potassium nitrate (KNO₃), cesium nitrate (CsNO₃), barium nitrate (Ba(NO₃)₂), ammonium nitrate (NH₄NO₃), lithium nitrite (LiNO₂), potassium nitrite (KNO₂), cesium nitrite (CsNO₂) and ammonium nitrate (NH₄NO₂); an organic nitric acid or nitrous acid compound such as methyl nitrate, dialkyl imidazolium nitrate, guanidine nitrate, imidazolium nitrate, pyridinium nitrate, ethyl nitrite, propyl nitrite, butyl nitrite, pentyl nitrite and octyl nitrite; or an organic nitro compound such as nitromethane, nitropropane, nitrobutane, nitrobenzene, dinitrobenzene, nitropyridine, dinitropyridine, nitrotoluene and dinitrotoluene, and preferably, the nitrogen compound may include lithium nitrate.

In an embodiment of the present disclosure, for example, the nitrogen compound may be included in an amount of 1 wt% to 10 wt%, 2 wt% to 10 wt% or 3 wt% to 10 wt%, specifically, 3 wt% to 8 wt%, 3 wt% to 6 wt% or 3 wt% to 5 wt%, based on the total weight of the electrolyte solution for a lithium secondary battery, but is not limited thereto. When the nitrogen compound is included in the above-described amount, the nitrogen compound may improve the electrical conductivity of the electrolyte solution and suppress the reduction of polysulfide when used in a lithium-sulfur battery, but the present disclosure is not limited thereto.

The organic solvent is a medium for the movement of ions that participate in the electrochemical reactions of a lithium secondary battery, and is used to dissolve the lithium salt and/or the nitrogen compound.

In the present disclosure, the organic solvent comprises an ether-based solvent.

In an embodiment of the present disclosure, the organic solvent may comprise the ether-based solvent in an amount of 80 vol% or more, for example, 85 vol% to 100 vol%, 90 vol% to 100 vol%, 95 vol% to 100 vol%, 98 vol% to 100 vol%, 90 vol% to 98 vol% or 90 vol% to 95 vol% based on the total volume of the organic solvent. When the amount of the ether-based solvent is in the above-described range based on the total volume of the organic solvent, it is possible to improve the solubility of the lithium salt and the nitrogen compound, but the present disclosure is not limited thereto.

In an embodiment of the present disclosure, the ether-based solvent may include at least one of linear ether or cyclic ether.

In an embodiment of the present disclosure, the linear ether may include, for example, at least one selected from the group consisting of dimethyl ether, diethyl ether, dipropyl ether, dibutyl ether, diisobutyl ether, ethyl methyl ether, ethyl propyl ether, ethyl tert-butyl ether, dimethoxymethane, trimethoxymethane, dimethoxyethane, diethoxyethane, dimethoxypropane, diethylene glycol dimethyl ether, diethylene glycol diethyl ether, triethylene glycol dimethyl ether, tetraethylene glycol dimethyl ether, ethylene glycol divinyl ether, diethylene glycol divinyl ether, triethylene glycol divinyl ether, dipropylene glycol dimethylene ether, butylene glycol ether, diethylene glycol ethyl methyl ether, diethylene glycol isopropyl methyl ether, diethylene glycol butyl methyl ether, diethylene glycol tert-butyl ethyl ether and ethylene glycol ethyl methyl ether. Preferably, the linear ether may include at least one selected from the group consisting of dimethyl ether, dimethoxyethane, diethoxyethane, diethylene glycol dimethyl ether, triethylene glycol dimethyl ether, and tetraethylene glycol dimethyl ether, and more preferably, diemethoxyethane.

In an embodiment of the present disclosure, the cyclic ether may include, for example, at least one selected from the group consisting of 2-methylfurane, 1,3-dioxolane, 4,5-dimethyl-dioxolane, 4,5-diethyl-dioxolane, 4-methyl-1,3-dioxolane, 4-ethyl-1,3-dioxolane, tetrahydrofuran, 2-methyltetrahydrofuran, 2,5-dimethyltetrahydrofuran, 2,5-dimethoxytetrahydrofuran, 2-ethoxytetrahydrofuran, 2-methyl-1,3,-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxy benzene, 1,3-dimethoxy benzene, 1,4-dimethoxy benzene and isosorbide dimethyl ether. Preferably, the cyclic ether may include at least one selected from the group consisting of 2-methylfurane, 1,3-dioxolane, tetrahydrofuran, 2-methyltetrahydrofuran, and 2,5-dimethyltetrahydrofuran, and more preferably, 2-methylfurane.

In an embodiment of the present disclosure, the organic solvent may comprise dimethoxyethane and 2-methylfurane.

In addition, the organic solvent may comprise the linear ether and the cyclic ether at a volume ratio of 95:5 to 5:95, preferably 95:5 to 50:50, and most preferably 90:10 to 70:30. As used herein, the term “volume ratio” refers to a ratio of “vol% of linear ether to vol% of cyclic ether” in the ether-based solvent.

In an embodiment of the present disclosure, the organic solvent may have high dissolving power for the nitrogen compound at room temperature. As described above, for the nitrogen compound to effectively take the above-described effect, the organic solvent needs to sufficiently dissolve the nitrogen compound.

In an embodiment of the present disclosure, for example, the organic solvent may have the dissolving power for the nitrogen compound in 2 g/100 g or more, for example, 2 g/100 g to 20 g/100 g, 3 g/100 g to 20 g/100 g, 3 g/100 g to 15 g/100 g, 5 g/100 g to 15 g/100 g, 5 g/100 g to 10 g/100 g or 7 g/100 g to 10 g/100 g at room temperature on the basis of 100 g of the organic solvent. When the organic solvent has the above-described dissolving power for the nitrogen compound, it is possible to reduce the consumption of the nitrogen compound and improve the performance of a lithium secondary battery, but the present disclosure is not limited thereto.

In an embodiment of the present disclosure, the ‘room temperature’ may range, for example, from 20° C. to 35° C., and more preferably from 25° C. to 30° C.

In an embodiment of the present disclosure, in addition to the ether-based solvent, the organic solvent may further comprise any other type of organic solvent that can dissolve the nitrogen compound. For example, organic solvents commonly used in electrolyte solutions of lithium secondary batteries may include the ether-based solvent as well as ester, amide, linear carbonate and cyclic carbonate, and in an embodiment of the present disclosure, in addition to the ether-based solvent, the organic solvent may further comprise the above-described organic solvent commonly used in electrolyte solutions of lithium secondary batteries. However, preferably, in terms of the solubility of the nitrogen compound, the electrolyte solution for a lithium secondary battery may not comprise the carbonate-based solvent as the organic solvent.

In an embodiment of the present disclosure, for example, the ester includes at least one selected from the group consisting of methyl acetate, ethyl acetate, propyl acetate, methyl propionate, ethyl propionate, propyl propionate, γ-butyrolactone, γ-valerolactone, γ-caprolactone, σ-valerolactone and ε-caprolactone, but is not limited thereto.

In an embodiment of the present disclosure, for example, the linear carbonate may typically include at least one selected from the group consisting of dimethyl carbonate, diethyl carbonate, dipropyl carbonate, ethyl methyl carbonate, methyl propyl carbonate and ethyl propyl carbonate, but is not limited thereto.

In an embodiment of the present disclosure, for example, the cyclic carbonate may include at least one selected from the group consisting of ethylene carbonate, propylene carbonate, 1,2-butylene carbonate, 2,3-butylene carbonate, 1,2-pentylene carbonate, 2,3-pentylene carbonate, vinylene carbonate, vinyl ethylene carbonate and halide thereof. The halide may include fluoroethylene carbonate, but is not limited thereto.

In another embodiment of the present disclosure, since the carbonate-based solvent does not dissolve the nitrogen compound or has low dissolving power for the nitrogen compound, the organic solvent may not comprise the carbonate-based solvent.

In an embodiment of the present disclosure, the organic solvent may comprise the carbonate-based solvent in a very small amount to avoid the influence of the carbonate-based solvent on the solubility of the nitrogen compound, and for example, when the organic solvent comprises the carbonate-based solvent, the amount of the carbonate-based solvent may be 3 wt% or less, 2 wt% or less, 1 wt% or less, 0.5 wt% or less or 0 wt% (i.e., no carbonate-based solvent) based on the total weight of the electrolyte solution for a lithium secondary battery.

The electrolyte solution for a lithium secondary battery according to the present disclosure may be, preferably, an electrolyte solution for a lithium-sulfur battery.

Due to comprising the above-described lithium salt, the electrolyte solution for a lithium secondary battery according to the present disclosure may have not only the improved oxidation stability but also the improved stability especially at high temperature since no or little decomposition of the lithium salt occurs.

More preferably, since the lithium salt hardly decomposes when stored even at high temperature of 60° C. or above, a lithium-sulfur battery comprising the same may have improved life characteristics at 45° C. or above.

In an embodiment of the present disclosure, for example, when the electrolyte solution for a lithium secondary battery is stored at high temperature, the LiTFSI does not dissolve or only dissolves in small amounts, maintaining 90 wt% or more of the initial weight of the LiFSI prior to storage.

When the electrolyte solution for a lithium secondary battery is stored at high temperature, for example, at 45° C. or more, 45° C. to 65° C., 50° C. to 60° C. or 55° C. to 60° C. for 2 weeks or more, for example, 2 weeks to 12 weeks, 2 weeks to 10 weeks, 3 weeks to 8 weeks, 3 weeks to 6 weeks, for example, 4 weeks to 5 weeks, the LiTFSI may maintain 90 wt% or more, for example, 90 to 100 wt%, 90 to 98 wt% or 93 to 96 wt% of the initial weight of the LiTFSI prior to storage.

In an embodiment of the present disclosure, the amount of the LiTFSI before and after the storage of the electrolyte solution for a lithium secondary battery may be measured by the common analysis method for measuring the amount of the electrolyte solution, for example, nuclear magnetic resonance analysis (NMR), ion chromatography and immediate constituent analysis.

### Lithium Secondary Battery

In addition, the present disclosure relates to a lithium secondary battery comprising a positive electrode, a negative electrode, a separator between the positive electrode and the negative electrode, and an electrolyte solution, wherein the electrolyte solution is the same as the above-described electrolyte solution of the present disclosure.

### Positive Electrode

The positive electrode may include a positive electrode current collector and a positive electrode active material layer coated on one or two surfaces of the positive electrode current collector.

The positive electrode current collector is not limited to a particular type of material and may include any type of material that supports the positive electrode active material and is highly conductive without causing any chemical change to the corresponding battery. For example, the positive electrode current collector may include copper, stainless steel, aluminum, nickel, titanium, palladium, sintered carbon, copper or stainless steel surface-treated with carbon, nickel or silver, and an aluminum-cadmium alloy.

The positive electrode current collector may have micro textured surfaces to enhance the bonding to the positive electrode active material, and may come in various shapes, for example, a film, a sheet, a foil, a mesh, a net, a porous body, a foam and a nonwoven web.

The positive electrode active material layer comprises a positive electrode active material and may further comprise a conductive material, a binder and an additive.

The positive electrode active material comprises a sulfur-carbon composite comprising a porous carbon material and sulfur in at least part of the inner and outer surfaces of the porous carbon material. Since the sulfur included in the positive electrode active material is not electrically conductive itself, the sulfur is combined with a conductive material such as a carbon material to form a composite. Therefore, the sulfur is included in the form of a sulfur-carbon composite.

Therefore, the lithium secondary battery of the present disclosure may be a lithium-sulfur battery.

The sulfur may include at least one selected from the group consisting of inorganic sulfur (Ss) and a sulfur compound. The positive electrode active material may comprise at least one selected from the group consisting of inorganic sulfur, Li₂Sₙ (n ≥ 1), a disulfide compound, an organic sulfur compound, and a carbon-sulfur polymer ((C₂Sₓ)ₙ, x = 2.5 to 50, n ≥ 2). Preferably, the sulfur may be inorganic sulfur.

The sulfur-carbon composite comprises the porous carbon material to provide frameworks for uniform and stable sulfur immobilization and replenish the low electrical conductivity of the sulfur for smooth electrochemical reactions.

In general, the porous carbon material may be made by carbonizing various carbon precursors. The porous carbon material includes non-uniform pores therein, and the average pore diameter may range from 1 to 200 nm and the porosity may range from 10 to 90% of the total volume of the porous carbon material. If the average pore diameter is less than the above-described range, the pore size is at molecular level, making sulfur impregnation impossible, and on the contrary, when the average pore diameter exceeds the above-described range, the porous carbon material has low mechanical strength, making it unsuitable for use in the electrode manufacturing process.

In an embodiment of the present disclosure, the ‘average pore diameter’ may be measured by the common method for measuring the pore diameter in a porous material, and the measurement method is not limited to a particular method. For example, the pore diameter may be measured by scanning electron microscopy (SEM), electric field transmission electron microscopy or a laser diffraction method. The measurement using the laser diffraction method may use, for example, commercially available laser diffraction particle size measurement devices (for example Microtrac MT 3000).

In an embodiment of the present disclosure, the ‘porosity’ refers to a fraction of the volume of pores in a structure over the total volume, and its unit is %, and may be interchangeably used with void fraction. In the present disclosure, the porosity may be measured by any method, and according to an embodiment of the present disclosure, the porosity may be measured, for example, by Brunauer-Emmett-Teller (BET) using nitrogen gas, Hg porosimeter and ASTM D2873.

The porous carbon material is not limited to a particular shape, and may have any shape commonly used in a lithium-sulfur battery, for example, spherical, rod-like, needle-like, platy, tubular or bulky.

The porous carbon material may include, without limitation, any type of porous carbon material having a porous structure or high specific surface area commonly used in the technical field. For example, the porous carbon material may include at least one selected from the group consisting of graphite; graphene; carbon black such as denka black, acetylene black, ketjen black, channel black, furnace black, lamp black and thermal black; carbon nanotubes (CNTs) such as single-walled carbon nanotubes (SWCNTs) and multi-walled carbon nanotubes (MWCNTs); carbon fibers such as graphite nanofibers (GNFs), carbon nanofibers (CNFs) and activated carbon fibers (ACFs); and graphite such as natural graphite, artificial graphite and expandable graphite, and activated carbon, but is not limited thereto. Preferably, the porous carbon material may include carbon nanotubes.

In the sulfur-carbon composite according to the present disclosure, the sulfur is in at least one of the inner and outer surfaces of the porous carbon material, and for example, the sulfur-carbon composite may be present in an area of less than 100%, preferably 1 to 95%, and more preferably 40 to 96% of the entire inner and outer surface of the porous carbon material. When the sulfur is present within the above-described range on the inner and outer surfaces of the porous carbon material, it is possible to provide the maximum effect in terms of electron transport area and wettability with the electrolyte. Specifically, the sulfur is impregnated with a thin and uniform distribution onto the inner and outer surfaces of the porous carbon material in the above-described range of area, thereby increasing the electron transport contact area during the charge and discharge. When the sulfur is present in an area of 100% of the total inner and outer surface of the porous carbon material, the porous carbon material is completely covered with the sulfur, resulting in low electrolyte wettability and decreased contact, thereby failing to accept electrons and participate in electrochemical reactions.

For example, the sulfur-carbon composite may comprise the sulfur in an amount of 65 wt% or more, and specifically 65 to 90 wt%, 70 to 85 wt% or 72 to 80 wt%, based on 100 wt% of the sulfur-carbon composite. When the sulfur content is in the above-described range, it is possible to improve the performance and capacity of the battery, but the present disclosure is not limited thereto.

The present disclosure is not limited to a particular method for producing the sulfur-carbon composite according to the present disclosure, and any common method in the technical field may be used. For example, the composite may be formed by mixing the sulfur with the porous carbon material and performing heat treatment.

In addition to the above-described constituents, the positive electrode active material may further comprise at least one selected from transition metal, Group IIIA elements, Group IVA elements, sulfur compounds of these elements, and alloys of these elements and sulfur.

The transition metal includes Sc, Ti, V, Cr, Mn, Fe, Co, Ni, Cu, Zn, Y, Zr, Nb, Mo, Tc, Ru, Rh, Pd, Os, Ir, Pt, Au or Hg, the Group IIIA elements include Al, Ga, In and Ti, and the Group IVA elements include Ge, Sn and Pb.

In the positive electrode for a lithium secondary battery according to the present disclosure, the positive electrode active material may be included, for example, in an amount of 80 wt% or more, specifically, 80 wt% to 100 wt%, and more specifically, 85 wt% to 98 wt%, or 80 wt% to 95 wt% based on the total weight of the positive electrode active material layer. The amount of the positive electrode active material may have a lower limit of 70 wt% or more or 85 wt% or more and an upper limit of 99 wt% or less or 90 wt% or less, based on 100 wt% of the positive electrode active material layer. The amount of the positive electrode active material may be set by a combination of the lower limit and the upper limit. When the amount of the positive electrode active material is less than the above-described range, the relative amount of the subsidiary material such as the conductive material and the binder increases and the amount of the positive electrode active material decreases, making it difficult to achieve high capacity and high energy density, and on the contrary, when the amount of the positive electrode active material exceeds the above-described range, the amount of the conductive material or the binder as described below is relatively insufficient, resulting in degradation of the physical properties of the electrode.

The conductive material plays a role in electrically connecting the electrolyte to the positive electrode active material and acts as a channel through which electrons move from the current collector to the positive electrode active material, and may include, without limitation, any material having conductive properties as the component of the electrode that is physically different from the carbon contained in the sulfur-carbon composite.

For example, the conductive material may include carbon black such as Super-P, denka black, acetylene black, ketjen black, channel black, furnace black, lamp black, thermal black or carbon black; carbon derivatives such as carbon nanotubes or fullerene; conductive fibers such as carbon fibers or metal fibers; metal powder such as fluorocarbon, aluminum powder and nickel powder; conductive polymer such as polyaniline, polythiophene, polyacetylene and polypyrrole, used alone or in combination.

The amount of the conductive material may be 1 to 10 wt% based on the total weight of the positive electrode active material. When the amount of the conductive material is less than the above-described range, it results in poor electron transport between the positive electrode active material and the current collector, leading to low voltage and low capacity. On the contrary, when the amount of the conductive material exceeds the above-described range, the proportion of the positive electrode active material decreases, resulting in a decrease in total energy (quantity of electric charge) of the battery, and thus it is desirable to determine the optimal amount of the conductive material within the above-described range.

The binder is used to bind the positive electrode active material to the positive electrode current collector and hold the positive electrode active material together to enhance the bond strength between them, and may include any binder known in the technical field.

For example, the binder may include any one selected from the group consisting of a fluorinated resin-based binder including at least one of polyvinylidene fluoride based polymer comprising at least one polyvinylidene fluoride (PVDF) or vinylidene fluoride repeating unit or polytetrafluoroethylene (PTFE); a rubber-based binder including styrene butadiene rubber (SBR), acrylonitrile-butadiene rubber and styrene-isoprene rubber; an acrylic binder; a cellulose-based binder including carboxymethyl cellulose (CMC), starch, hydroxypropyl cellulose and regenerated cellulose; a polyalcohol-based binder; a polyolefin-based binder including polyethylene and polypropylene; a polyimide-based binder; a polyester-based binder; and a silane-based binder, or a copolymer thereof.

The amount of the binder may be 1 to 10 wt% based on the total weight of the positive electrode active material layer. When the amount of the binder is less than the above-described range, it results in degradation of the physical properties of the positive electrode, leading to debonding of the positive electrode active material and the conductive material, and when the amount of the binder exceeds the above-described range, the proportion of the positive electrode active material and the conductive material decreases, causing a drop in battery capacity, and thus it is desirable to determine the optimal amount of the binder within the above-described range.

The present disclosure is not limited to a particular method for manufacturing the positive electrode for a lithium secondary battery, and any method known to those skilled in the art or variations thereof may be used.

For example, the positive electrode for a lithium secondary battery may be manufactured by preparing a positive electrode slurry composition including the above-described composition, and coating the slurry on at least one surface of the positive electrode current collector to form the positive electrode active material layer.

The positive electrode slurry composition comprises the above-described positive electrode active material, and may further comprise a binder, a conductive material and a solvent.

The solvent may be one capable of dispersing the positive electrode active material homogeneously. Preferably, the solvent may be an aqueous solvent, for example, water, and in this instance, water may be distilled water or deionized water. However, the solvent is not limited thereto, and lower alcohol that is highly miscible with water may be used as necessary. The lower alcohol may include methanol, ethanol, propanol, isopropanol and butanol, and may be preferably used in combination with water.

The solvent may be included in such an amount that the slurry has a proper concentration for easy coating, and the specific amount changes depending on the coating method and device.

If necessary, the positive electrode slurry composition may further comprise a material commonly used in the technical field to improve the function, for example, a viscosity modifier, a fluidizing agent and a filler.

The present disclosure is not limited to a particular coating method of the positive electrode slurry composition, and for example, the coating method may include doctor blade, die casting, comma coating and screen printing. For example, after coating the positive electrode slurry on a substrate, the coated slurry may be pressed or laminated on the positive electrode current collector.

After the coating, a drying process may be performed to remove the solvent. The drying process is performed at a sufficient temperature for a sufficient length of time to remove the solvent, and the conditions may change depending on the type of solvent, and the present disclosure is not limited to a particular condition. For example, the drying method may include warm air drying, hot air drying, low humidity air drying, vacuum drying and drying by (far) infrared ray and electron beam irradiation. The drying rate is adjusted to remove the solvent as quickly as possible within a sufficient level of rate range for preventing cracks in the positive electrode active material layer or peel off from the positive electrode current collector due to stress concentration.

In addition, the current collector may be pressed after the drying step in order to increase the density of the positive electrode active material in the positive electrode. The pressing step may be carried out by using a mold pressing, a roll pressing, or the like.

The positive electrode, to be specific, the positive electrode active material layer, made by the above-described composition and manufacturing method, may have porosity of 50 to 80%, specifically 60 to 75%. When the porosity of the positive electrode is lower than 50%, the fill factor of the positive electrode slurry composition comprising the positive electrode active material, the conductive material and the binder is too high to maintain enough electrolytes to ensure ionic conductivity and/or electrical conductivity between the positive electrode active materials, resulting in degradation of the output characteristics or cycle characteristics of the battery and aggravation of overvoltage and decrease in discharge capacity in the battery. On the contrary, when the porosity of the positive electrode is higher than 80%, it results in low physical and electrical connection to the current collector, decreased adhesion, inadequate reactions and low energy density of the battery due to a larger number of pores filled with the electrolyte, and thus the porosity of the positive electrode is appropriately adjusted within the above-described range.

### Negative Electrode

The negative electrode may include a negative electrode current collector and a negative electrode active material layer coated on one or two surfaces of the negative electrode current collector. Alternatively, the negative electrode may be a lithium metal plate.

The negative electrode current collector is used to support the negative electrode active material layer, and reference is made to the description of the positive electrode current collector.

The negative electrode active material layer comprises a negative electrode active material, and may comprise a conductive material and a binder. In this instance, the conductive material and the binder are the same as described above.

The negative electrode active material may include a material capable of reversibly intercalating or deintercalating lithium (Li⁺), a material capable of reacting with lithium ions to reversibly form a lithium-containing compound, or lithium metal or a lithium alloy.

For example, the material capable of reversibly intercalating or deintercalating lithium (Li⁺) may include at least one of crystalline carbon or amorphous carbon. For example, the material capable of reacting with lithium ions to reversibly form a lithium-containing compound may include tin oxide, titanium nitrate or silicon. For example, the lithium alloy may include an alloy of lithium and a metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al) and tin (Sn).

Preferably, the negative electrode active material may be lithium metal, and specifically, in the form of a lithium metal foil or a lithium metal powder.

### Separator

The separator serves to separate or insulate the positive electrode from the negative electrode and allow lithium ions to move between the positive electrode and the negative electrode, and may be made of a porous non-conductive or insulating material, and the separator may include, without limitation, any type of material commonly used for a separator for a lithium secondary battery. The separator may be an independent member, such as a film, or a coating layer formed on the positive electrode and/or the negative electrode.

Preferably, the separator may have low resistance to electrolyte ion transport and high wettability by the electrolyte.

The separator may include a porous substrate, and the porous substrate may include any porous substrate commonly used in a secondary battery, and a porous polymer film may be used alone or in stack, and for example, a non-woven fabric made of high-melting point glass fibers and polyethylene terephthalate fibers or a polyolefin-based porous membrane may be used, but is not limited thereto.

The present disclosure is not limited to a particular material of the porous substrate, and any porous substrate commonly used in an electrochemical device may be used. For example, the porous substrate may include at least one material selected from the group consisting of polyolefin such as polyethylene and polypropylene, polyester such as polyethylene terephthalate and polybutylene terephthalate, polyamide, polyacetal, polycarbonate, polyimide, polyetherether ketone, polyether sulfone, polyphenylene oxide, polyphenylene sulfide, polyethylene naphthalene, polytetrafluoroethylene, polyvinylidene fluoride, polyvinyl chloride, polyacrylonitrile, cellulose, nylon, poly(p-phenylene benzobisoxazole) and polyarylate.

The porous substrate is not limited to a particular thickness, but the thickness of the porous substrate may be 1 to 100 µm, and preferably 5 to 50 µm. The thickness range of the porous substrate is not limited to the above-described range, but when the thickness is so much smaller than the above-described lower limit, the separator may have poor mechanical properties, causing damage to the separator while the battery is being used.

The average pore diameter and porosity of the porous substrate are not limited to a particular range, but may be 0.001 to 50 µm and 10 to 95%, respectively.

The lithium secondary battery according to the present disclosure may be manufactured by a winding process commonly used and a lamination (stacking) process and a folding process of the separator and the electrode.

The lithium secondary battery is not limited to a particular shape, and may come in various shapes, for example, a cylindrical shape, a stack shape, a coin-type shape and a pouch-type shape.

Hereinafter, an exemplary embodiment will be presented to help better understanding of the present disclosure, but the following embodiment is provided to describe the present disclosure by way of illustration, and it is obvious to those skilled in the art that a variety of changes and modifications may be made within the scope and technical aspect of the present disclosure and it is apparent that such changes and modifications fall in the appended claims.

### <Preparation of Electrolyte Solution for Lithium-Sulfur Battery>

### Examples 1 to 4 and Comparative Example 1

An electrolyte solution for a lithium-sulfur battery is prepared according to the composition as shown in the following Table 1.

TABLE 1

| | Lithium salt | | Organic solvent | Nitrogen compound |
|---|---|---|---|---|
| | Type | Concentration | | |
| Example 1 | LiTFSI | 0.1875 M | 2-MeF:DME (2:8 (v/v)) | LiNO₃ |
| | LiFSI | 0.5625 M | | |
| Example 2 | LiTFSI | 0.375 M | | |
| | LiFSI | 0.375 M | | |
| Example 3 | LiTFSI | 0.5625 M | | |
| | LiFSI | 0.1875 M | | |
| Example 4 | LiTFSI | 0.75 M | | |
| | LiFSI | - | | |
| Comparative Example 1 | LiTFSI | - | | |
| | LiFSI | 0.75 M | | |

The nitrogen compound is included in an amount of 5 wt% based on the total weight of the electrolyte solution for a lithium-sulfur battery, and 2-MeF is 2-methylfuran, and DME is dimethoxyethane.

### Experimental Example 1. Evaluation of Oxidation Stability of Electrolyte Solution for Lithium-Sulfur Battery

For each electrolyte solution for a lithium-sulfur battery prepared in examples 1 to 4 and comparative example 1, oxidation stability evaluation is conducted.

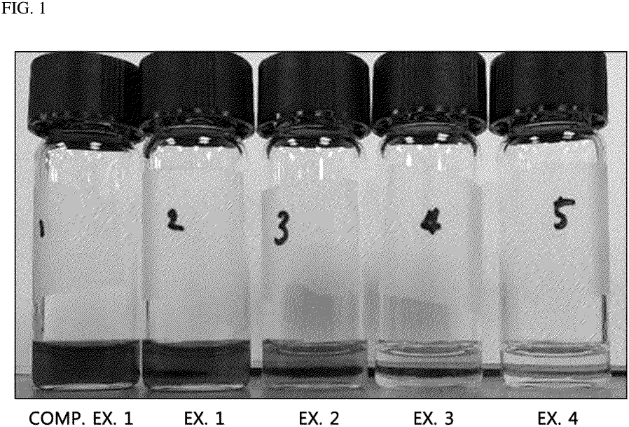

The oxidation stability evaluation is conducted by observing the extent of browning of each electrolyte solution for a lithium-sulfur battery prepared in examples 1 to 4 and comparative example 1 when sealed into a vial after exposed to air (20% oxygen, 25° C., 1 atm) and the results are shown in FIG. 1. The electrolyte solutions of examples 1 to 4 and comparative example 1 were observed for the extent of browning after 24 hours.

Referring to FIG. 1, browning by oxidation through the oxygen of the air within the vial is observed in each electrolyte solution for a lithium-sulfur battery prepared in examples 1 to 4 and comparative example 1, but it can be seen that as the concentration of lithium bis(trifluoromethanesulfonyl)imide (LiTFSI) increases, the extent of browning decreases.

Therefore, it can be seen that as the concentration of lithium bis(trifluoromethanesulfonyl)imide as the lithium salt of the electrolyte is higher, oxidation stability is higher.

### Experimental Example 2. Evaluation of High Temperature (60° C.) Stability Of Electrolyte Solution for Lithium-Sulfur Battery

After storage of each electrolyte solution for a lithium-sulfur battery prepared in examples 2 and 3 and comparative example 1 within a high temperature chamber of 60° C. for 4 weeks in sealed state, high temperature stability is evaluated by quantitatively analyzing the lithium salt remaining in the electrolyte solution.

Specifically, quantitative analysis of lithium salt was performed by NMR analysis using isotopes and ion chromatography (IC) analysis after organic solvent extraction using THF for each electrolyte solution for a lithium-sulfur battery of examples 2 and 3 and comparative example 1, and the results are shown in the following Table 2. The following Table 2 shows a ratio (%) of the weight of the remaining lithium salt to the initial weight of the lithium salt.

TABLE 2

| | LiTFSI | LiFSI |
|---|---|---|
| Example 2 | 98% | 0% |
| Example 3 | 96% | 0% |
| Comparative Example 1 | - | 0% |

The results of Table 2 reveal that LiFSI does not remain and completely decomposes. However, the results also reveal that the LiTFSI remains up to 98%.

Therefore, it can be seen that the LiTFSI does not decompose at high temperature (60° C.), showing high temperature stability.

### Experimental Example 3. Evaluation of Capacity Retention After High Temperature (60° C.) Storage of Lithium-Sulfur Battery

95 wt% of a sulfur-carbon composite (S:C = 75:25 (weight ratio)) as a positive electrode active material is mixed with 5 wt% of lithium polyacrylate (LiPAA) as a binder to prepare a positive electrode slurry composition. The positive electrode slurry composition is coated on an aluminum current collector and dried to manufacture a positive electrode. The manufactured positive electrode has a loading amount of 3.5 to 4.5 mAh/cm².

Lithium metal is used for a negative electrode.

A polyethylene separator having the thickness of 16 µm and the porosity of 46% is interposed between the positive electrode and the negative electrode, and each electrolyte solution prepared in examples 2 and 3 and comparative example 1 is injected to manufacture a pouch cell-type lithium-sulfur battery.

The pouch-cell type lithium-sulfur battery has no exposure of the electrolyte solution to air.

Specifically, each electrolyte prepared in examples 2 and 3 and comparative example 1 is used after stored for 1 week, 2 weeks, 3 weeks and 4 weeks, and the pouch cell-type lithium-sulfur battery comprising the electrolyte solution is tested to evaluate the capacity retention, and the test is repeated for 4 weeks.

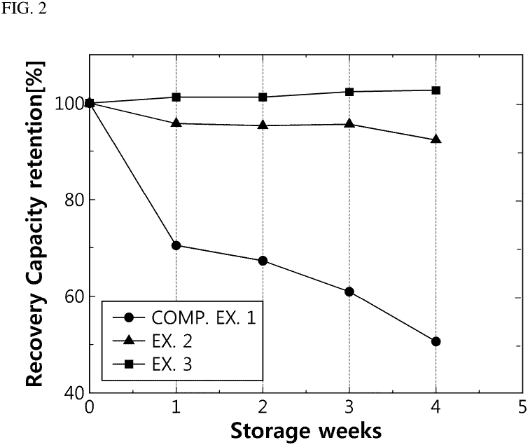

The capacity retention is calculated on the basis of the fourth discharge capacity in four charge/discharge cycles at 0.1 C before the storage, and the fourth discharge capacity in four discharge/charge cycles at 0.1 C after the storage, and the results are shown in FIG. 2.

The results of FIG. 2 reveal that comparative example 1 with no LiTFSI as the lithium salt has a significant decline in capacity retention as the high temperature storage of the electrolyte solution is longer.

The results also reveal that even though the electrolyte solution is stored at high temperature for a prolonged time, example 2 with LiTFSI and LiFSI at the same molar concentration, and example 3 with LiTFSI at a higher molar concentration than LiFSI retain the capacity.

It is found that in the experimental example 2, when the electrolyte solution is stored within the high temperature chamber of 60° C. for 4 weeks in sealed state, most of LiTFSI remains while LiFSI completely decomposes.

Therefore, it is expected from the results of example 3 that LiFSIdecomposes over time, and accordingly, it can be seen that examples 2 and 3 with higher concentration of LiTFSI shows the improved capacity retention.

It can be seen from the above results that the electrolyte solution for a lithium-sulfur battery according to the present disclosure has the improved storage stability at a high temperature (60° C.), leading to the improved capacity retention of a lithium-sulfur battery comprising the same.

### Experimental Example 4. Evaluation of High Temperature (45° C.) Characteristics of Coin Cell-Type Lithium-Sulfur Battery

A coin cell-type lithium sulfur battery comprising each electrolyte solution for a lithium-sulfur battery according to examples 1 to 4 and comparative example 1 is manufactured by the same method as the experimental example 3, except that lithium metal is coated on a copper current collector to manufacture a negative electrode.

The coin cell-type lithium-sulfur battery is subjected to oxidation by the exposure of the electrolyte solution to air.

For each coin cell-type lithium-sulfur battery comprising the electrolyte solutions for a lithium-sulfur battery according to examples 1 to 4 and comparative example 1, life characteristics are evaluated using a charge/discharge tester (LAND CT-2001A, available from Wuhan Co.)

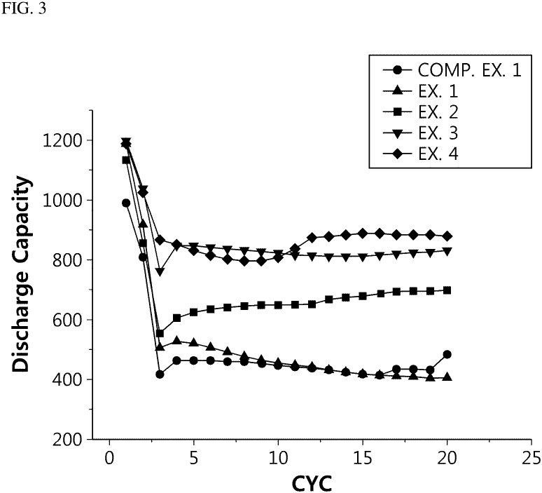

Specifically, life characteristics are measured after repeating 2.5 times the discharge at the current density of 0.1 C at 45° C. until 1.8 V and the charge with constant current until 2.5 V, and repeating the discharge/charge at the current density of 0.2 C three times, followed by cycling at a current density of 0.5 C, and the results are shown in FIG. 3.

The results of FIG. 3 reveal that comparative example 1 with no LiTFSI as the lithium salt has poor life characteristics at 45° C.

Example 1 comprises LITFSI and LIFSI as the lithium salt, but the molar concentration of LITFSI is lower than the molar concentration of LIFSI, and in the similar way to comparative example 1, example 1 exhibits poor life characteristics.

Example 2 comprises LITFSI and LiFSI at the same molar concentration, and exhibits the improved life characteristics at 45° C.

Example 3 comprises LITFSI at a higher molar concentration than the molar concentration of lithium bis(fluorosulfonyl)imide, and example 4 comprises LITFSI alone, and both examples 3 and 4 have the improved life characteristics at 45° C., showing better results than example 2.

It can be seen from the above results that comprising LITFSI as the lithium salt, or comprising LiTFSI at higher molar concentration than the molar concentration of LIFSI provides the improved life characteristics at high temperature (45° C.).

### Experimental Example 5. Evaluation of High Temperature (45° C.) Performance of Pouch Cell-Type Lithium-Sulfur Battery

A pouch cell-type lithium sulfur battery comprising each electrolyte solution for a lithium-sulfur battery prepared in examples 2 to 4 and comparative example 1 is manufactured by the same method as the experimental example 3.

The pouch-cell type lithium-sulfur battery has no exposure of the electrolyte solution to air.

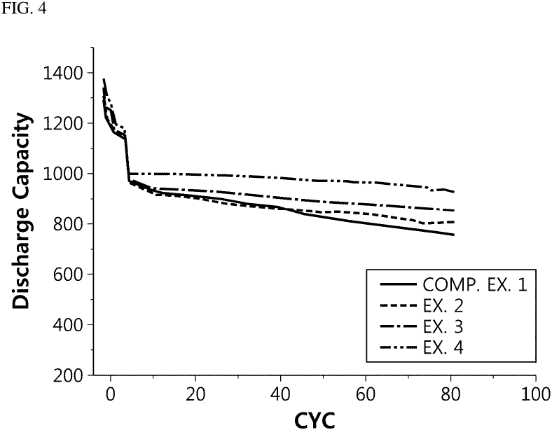

The life characteristics are evaluated under the same condition as the experimental example 4, and the results are shown in FIG. 4.

The results of FIG. 4 show the same tendency as the results of FIG. 3. However, since the electrolyte solution of the pouch cell-type lithium-sulfur battery is not subjected to oxidation with no exposure to air, the pouch cell-type lithium-sulfur battery shows better performance at high temperature than the coin cell-type lithium-sulfur battery.

### Experimental Example 6. Evaluation of Solubility of Nitrogen Compound According to the Type of Organic Solvent

The solubility of the nitrogen compound in an ether-based solvent and a carbonate-based solvent is evaluated using lithium nitrate (LiNO₃) as follows.

An electrolyte solution according to example 4 comprising the ether-based solvent is prepared. Subsequently, an electrolyte solution of comparative example 2 is prepared by the same method as example 4 except that the organic solvent is changed from 2-MeF:DME (2:8 v/v) to ethyl carbonate (EC):dimethyl carbonate (DMC) (1:2 v/v).

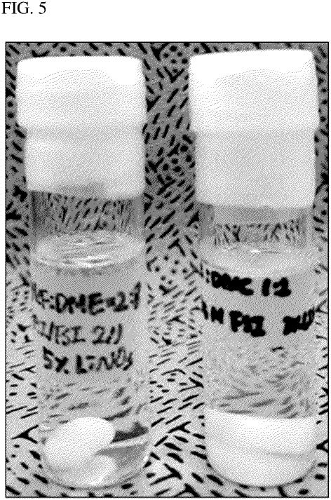

FIG. 5 is an image of the prepared electrolyte solution (left: example 4, right: comparative example 2)

Additionally, when preparing example 4 and comparative example 2, a lithium salt is dissolved in the organic solvent prepared at room temperature (25° C.), lithium nitrate is added, and the amount of lithium nitrate is measured at the time when lithium nitrate does not dissolve and is deposited. The measured amount of lithium nitrate indicates solubility in 100 g of the organic solvent and the results are shown in the following Table 3.

TABLE 3

| | Organic solvent | Solubility (g/100 g) |
|---|---|---|
| Example 4 | 2-MeF:DME (2:8 (v/v)) | 9 |
| Comparative Example 2 | EC:DMC (1:2 (v/v) | 0.2 |

Referring to the results of FIG. 5 and Table 3, it is found that when the electrolyte solution for a lithium secondary battery comprises the nitrogen compound, it is desirable to comprise the ether-based solvent as the organic solvent to exploit the nitrogen compound.

1. An electrolyte solution for a lithium secondary battery, comprising:
a lithium salt;
a nitrogen compound; and
an organic solvent,
wherein the lithium salt comprises lithium bis(trifluoromethanesulfonyl)imide (LiTFSI), and
wherein the organic solvent comprises an ether-based solvent.

2. The electrolyte solution for a lithium secondary battery according to claim 1, wherein the LiTFSI is included in an amount of 20 mol% or more based on a total number of moles of the lithium salt.

3. The electrolyte solution for a lithium secondary battery according to claim 1, wherein the lithium salt is included in a molar concentration of 0.1 M to 4 M.

4. The electrolyte solution for a lithium secondary battery according to claim 1, wherein the lithium salt further comprises lithium bis(fluorosulfonyl)imide (LiFSI), and wherein a molar concentration of the LiTFSI is equal to or higher than a molar concentration of the LiFSI.

5. The electrolyte solution for a lithium secondary battery according to claim 1, wherein the ether-based solvent is included in an amount of 80 vol% or more based on a total volume of the organic solvent.

6. The electrolyte solution for a lithium secondary battery according to claim 1, wherein the ether-based solvent comprises at least one of a linear ether or a cyclic ether.

7. The electrolyte solution for a lithium secondary battery according to claim 6, wherein the linear ether comprises at least one selected from the group consisting of dimethyl ether, diethyl ether, dipropyl ether, dibutyl ether, diisobutyl ether, ethyl methyl ether, ethyl propyl ether, ethyl tert-butyl ether, dimethoxymethane, trimethoxymethane, dimethoxyethane, diethoxyethane, dimethoxypropane, diethylene glycol dimethyl ether, diethylene glycol diethyl ether, triethylene glycol dimethyl ether, tetraethylene glycol dimethyl ether, ethylene glycol divinyl ether, diethylene glycol divinyl ether, triethylene glycol divinyl ether, dipropylene glycol dimethylene ether, butylene glycol ether, diethylene glycol ethyl methyl ether, diethylene glycol isopropyl methyl ether, diethylene glycol butyl methyl ether, diethylene glycol tert-butyl ethyl ether, and ethylene glycol ethyl methyl ether.

8. The electrolyte solution for a lithium secondary battery according to claim 6, wherein the cyclic ether comprises at least one selected from the group consisting of 2-methylfurane, 1,3-dioxolane, 4,5-dimethyl-dioxolane, 4,5-diethyl-dioxolane, 4-methyl-1,3-dioxolane, 4-ethyl-1,3-dioxolane, tetrahydrofuran, 2-methyltetrahydrofuran, 2,5-dimethyltetrahydrofuran, 2,5-dimethoxytetrahydrofuran, 2-ethoxytetrahydrofuran, 2-methyl-1,3,-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxybenzene, 1,3-dimethoxybenzene, 1,4-dimethoxybenzene, and isosorbide dimethyl ether.

9. The electrolyte solution for a lithium secondary battery according to claim 1, wherein the organic solvent has a dissolving power of 2 g/100 g or more for the nitrogen compound at room temperature, based on 100 g of the organic solvent.

10. The electrolyte solution for a lithium secondary battery according to claim 9, wherein the room temperature is in a range of 20° C. to 35° C.

11. The electrolyte solution for a lithium secondary battery according to claim 1, wherein the organic solvent does not comprise a carbonate-based solvent.

12. The electrolyte solution for a lithium secondary battery according to claim 11, wherein the carbonate-based solvent includes at least one of dimethyl carbonate, diethyl carbonate, dipropyl carbonate, ethylmethyl carbonate, methylpropyl carbonate, ethylpropyl carbonate, ethylene carbonate, propylene carbonate, 1,2-butylene carbonate, 2,3-butylene carbonate, 1,2-pentylene carbonate, 2,3-pentylene carbonate, vinylene carbonate, vinylethylene carbonate, or a halide thereof.

13. The electrolyte solution for a lithium secondary battery according to claim 1, wherein the nitrogen compound comprises a nitric acid compound or a nitrous acid-based compound.

14. The electrolyte solution for a lithium secondary battery according to claim 1, wherein the nitrogen compound is included in an amount of 2 wt% to 10 wt% based on a total weight of the electrolyte solution.

15. The electrolyte solution for a lithium secondary battery according to claim 1, wherein the electrolyte solution retains, after storage at a temperature of 45° C. or more, 90 wt% or more of LiTFSI relative to an initial weight of LiTFSI prior to storage.

16. The electrolyte solution for a lithium secondary battery according to claim 15, wherein the electrolyte solution retains, after storage at a temperature of 45° C. or more for 4 weeks, 90 wt% to 98 wt% of LiTFSI relative to the initial weight of LiTFSI prior to storage.

17. The electrolyte solution for a lithium secondary battery according to claim 15, wherein the storage temperature is 45° C. to 65° C.

18. A lithium secondary battery, comprising:
a positive electrode;
a negative electrode;
a separator between the positive electrode and the negative electrode; and
the electrolyte solution of claim 1.

19. The lithium secondary battery according to claim 18, wherein the positive electrode comprises a positive electrode active material, wherein the positive electrode active material comprises a sulfur-containing compound.

20. The lithium secondary battery according to claim 19, wherein the sulfur-containing compound comprises at least one of inorganic sulfur (Ss), lithium polysulfide (Li₂Sn, 1≤n≤8), or carbon sulfur polymer (C₂Sx)m, 2.5≤x≤50, 2≤m).

21. The lithium secondary battery according to claim 18, wherein the negative electrode comprises a negative electrode active material, wherein the negative electrode active material comprises at least one of a lithium metal or a lithium alloy.

22. The lithium secondary battery according to claim 18, wherein the lithium secondary battery is a coin-type battery or a pouch-type battery.
